(19) United States
(12) Patent Application Publication
(10) Pub. No.: US 2024/0313342 A1
(43) Pub. Date: Sep. 19, 2024

(54) ENERGY STORAGE VENTING DEVICE

(71) Applicant: Airbus (SAS), Blagnac (FR)

(72) Inventor: Sasank KOMARLA, Bristol (GB)

(21) Appl. No.: 18/587,562

(22) Filed: Feb. 26, 2024

(30) Foreign Application Priority Data
Mar. 15, 2023 (IN) 202311017468

(51) Int. Cl. H01M 50/367; H01M 50/342; H01M 50/358

(52) U.S. Cl. CPC H01M 50/367; H01M 50/3425; H01M 50/358; H01M 2200/20; H01M 2220/20

(57) ABSTRACT

A venting device 9a; 9b; 9c for a battery including a fluid flow path with an outlet duct 14a, 22; a burst disc 13; and a flexible coupling 15 downstream of the burst disc. The flexible coupling 15 includes a sleeve 16 of elastomeric material substantially coaxial with the outlet duct 4a and having cross-sectional dimensions substantially the same as those of the outlet duct. The provision of a flexible coupling 15 is coaxial with the outlet duct 14a and has the same internal dimensions The elastomeric fabric 16 is arranged to expand to absorb a shock wave and return to its normal dimensions to reduce turbulent flow through the flexible coupling.

### RELATED APPLICATION

This application incorporates by reference and claims priority to India patent application IN 202311017468, filed Mar. 15, 2023.

### FIELD OF TECHNOLOGY

This invention relates to a venting device for an energy storage system such as a battery or system of batteries. The invention further relates to an energy storage system including such a venting device, and to a vehicle including such a venting device and/or energy storage system, such as an aircraft.

### BACKGROUND

An aircraft conventionally includes an electrical system arranged to energize various devices on the aircraft, such as flight instruments, navigation aids, cabin heating and lighting. An aircraft's electrical system typically includes one or more batteries arranged to store electrical energy. Previously, lead-acid or Nickel-Cadmium batteries were employed, but there has recently been a move towards Lithium ion batteries, which are rechargeable and dependable. A typical aircraft battery installation comprises groups of cells contained in one or more enclosures or modules.

A problem which may be encountered with aircraft batteries is that, if the battery deteriorates, hot gases can be emitted which must be evacuated to the environment outside of the aircraft. To this end, a venting system is provided between the, or each, battery pack and a vent on the exterior surface of the vehicle.

It has been proposed to utilize a burst disc (also known as a rupture disc) as a pressure relief safety valve. The burst disc is arranged to rupture when the pressure inside a battery module increases beyond a predetermined threshold. It has been found that the hot and high pressure exhaust flow from a ruptured disc has a Mach number which is close to 1 i.e. close to the speed of sound. This can cause a shock wave to be generated in the venting system. Such shock waves can change the properties of the fluid flow in the venting system, causing abrupt changes in temperature, pressure and density. Furthermore, in order to withstand this excess pressure, the venting system is typically made to be very strong and relatively heavy, which is detrimental from the point of view of fuel consumption for the aircraft.

### BRIEF SUMMARY

The invention provides a venting device for an energy storage system comprising a fluid flow path including at least one outlet duct; a burst disc; and a flexible coupling downstream of the burst disc, the flexible coupling comprising a sleeve of elastomeric material substantially coaxial with the outlet duct and having cross-sectional dimensions substantially the same as those of the outlet duct. The provision of a flexible coupling that is coaxial with the outlet duct and has the same internal dimensions as it results in a substantially smooth and continuous fluid flow path, even in the presence of a shock wave from the burst disc. The elastomeric fabric is arranged to expand to absorb such a shock wave and return to its normal dimensions to reduce turbulent flow.

Previously, it had been proposed to use a combination of a burst disc with a bellows-type expansion joint arranged to absorb the shock wave from the flow emerging from the burst disc. However, it has been found that the corrugated interior surface of the bellows has the capability to cause complicated shock patterns having very strong areas of compression, resulting in increased turbulence, excessive vibration, noise and flow related losses due to the high speed flow over a wavy surface.

The internal surface of the sleeve may be substantially smooth.

The outlet duct may comprise a first portion between the burst disc and the flexible coupling; and a second portion downstream of the flexible coupling.

The elastomeric material may comprise a fluoro-elastomer.

The venting device may comprises at least one flange arranged to support an end portion of the sleeve. The sleeve may be connected to the flange by means of fasteners.

The sleeve may have a circular or rectangular cross section, in dependence on the shape of the outlet duct.

The energy storage system may have a housing having an outlet to the burst disc.

The invention may further provide an energy storage system comprising at least one battery in a housing and a venting device constructed according to the first aspect of the invention. Preferably, a plurality of batteries is provided in a plurality of housings, with each housing being associated with a venting device constructed according to the first aspect of the invention.

The invention may be configured for a vehicle including an energy storage system.

A venting system may be provided comprising at least one duct between the, or each, venting device and an exterior surface of the vehicle. The vehicle may take the form of an aircraft.

### DESCRIPTION OF THE DRAWINGS

The invention will now be described, by way of example, with reference to the accompanying drawings in which:

FIG. 1 is a side view of an aircraft including an energy storage venting system constructed according to an embodiment of the invention;

FIG. 2 is a schematic diagram of the venting system of FIG. I;

FIG. 3 is a schematic diagram of the venting device of the venting system of FIGS. 1 and 2; and

FIG. 4 is a schematic diagram of an alternative embodiment of the venting device of the venting system of FIGS. 1 and 2.

### DETAILED DESCRIPTION

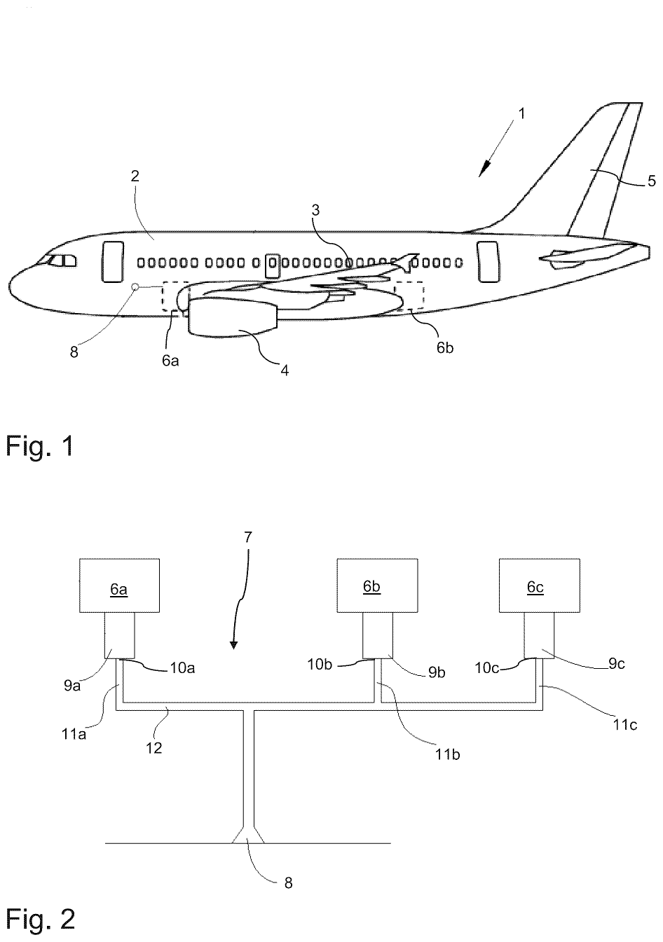

With reference to FIG. 1, an aircraft in the form of a typical transonic commercial passenger aircraft 1 The aircraft 1 comprises a fuselage 2, wings 3, main engines 4 and a tail 5. The aircraft 1 further contains within it an energy storage system. The energy storage system comprises a plurality of battery packs, two of which 6a, 6b are shown in broken lines in FIG. 1. Each battery packs 6a, 6b comprise a housing containing at least one battery or cell, for example a lithium-ion battery. The batteries are arranged to provide electrical power to devices on the aircraft through electrical conductors (not shown) running between the battery packs 6a, 6b and the electrical devices.

In the event of deterioration of one or more of the batteries, a venting system is provided for the removal of gases, which venting system 7. The general layout of an exemplary venting system 7 is shown in FIG. 2. The venting system 7 is arranged to fluidly connect the energy storage system to the ambient environment via an exit port 8 in the outer skin of the aircraft.

With reference to FIG. 2, the energy storage system comprises a plurality of battery packs 6a to 6c, including the two packs 6a, 6b shown in FIG. 1. Any number of battery packs 6a to 6c could be provided. Bach battery pack 6a to 6c is fluidly connected to the venting system 7 via a venting devices 9a to 9c, which will be described in more detail later in this specification. The respective outlets 10a to 10c of each venting device are connected to respective exhaust ducts, e.g., pipes 11a to 11c. The exhaust ducts 11a to 11c are fluidly connected to a main line 12 that is also connected to exit port 8 arranged through the outer skin of the aircraft 1. Thus, any gases emitted by one or more of the batteries can be vented to the atmosphere through the system of ducts 11a to 11c, 12.

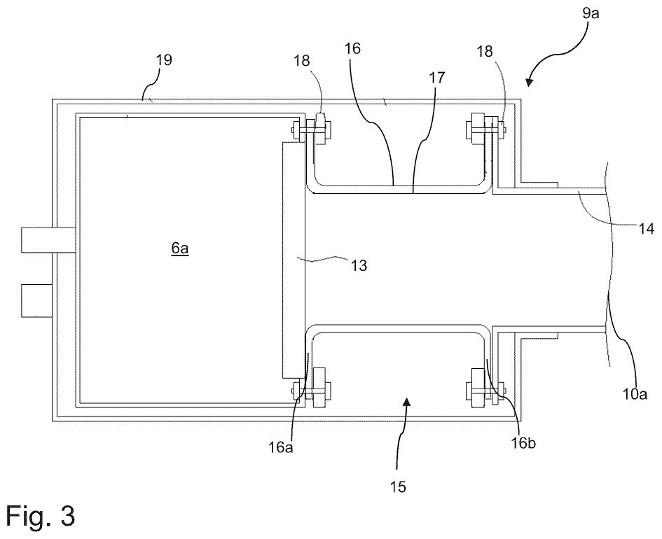

Deterioration of a battery can also result in the generation of excess pressure, which can propagate through the venting system 7. To prevent such propagation, each battery pack 6a to 6c is associated with a respective venting device 9a to 9c, an example of which is shown in FIG. 3. In this embodiment, the venting device 9a comprises a burst disc 13, an outlet duct 14 downstream of the burst disc and a flexible coupling 15 between the burst disc 13 and the outlet duct 14.

A burst disc is a device that is calibrated to rupture when the pressure exerted on it exceeds a predetermined threshold. In this embodiment, the burst disc 13 is arranged to form part of a face of one of the battery pack housings 6a. The mechanical resistance of the burst disc 13 is lower than the mechanical resistance of the other faces of the battery pack 6a to ensure that the burst disc will rupture before any other part of the battery pack housing. Thus, the burst disc 13 provides an outlet for gases when the pressure of those gases inside the battery pack 6a exceeds the predetermined threshold.

When the burst disc 13 ruptures, the outgoing gas flow may be hot and at high pressure, leading to a shock wave being produced. The flexible coupling 15 is arranged to deform and thus absorb or dampen any shock waves. Flexible coupling 15 comprises a tube or sleeve 16 of an elastomeric fabric. Fabric sleeve 16 is preferably formed from a fluoro-elastomer, which is a fluorocarbon-based synthetic rubber. Fluoro-elastomers are typically resistant to chemicals, heat and abrasion. The sleeve 16 has an interior surface 17 that is substantially smooth. The cross-sectional dimensions of the inner surface of the sleeve are substantially the same as those of the outlet duct 14, so that the sleeve and outlet duct form a smooth continuous flow path for gases emerging from the burst disc 13.

The fabric sleeve 16 is arranged to be fastened to rigid components of the venting system 7. For example, in FIG. 3, one end portion 16a of the sleeve is arranged to lie against the face of the battery pack that includes the burst disc 13 and is connected to it so that the sleeve 16 of elastomeric fabric surrounds the burst disc 13. The end portion 16a of the sleeve may be connected to the housing of the battery pack 6a by fasteners such as nuts and bolts, one of which 18 is shown in FIG. 3. The other end portion 16b of the sleeve is attached to a flange 14a which is formed at one end portion of the outlet duct 14 or pipe downstream of the flexible coupling 15. The end portion 16b of the sleeve may also be connected to the flange by fasteners such as simple nut and bolt arrangements, one of which 18 is also shown in FIG. 3. The second end portion 16b of the sleeve is supported by flange 14a. The outlet duct 14 is connectable to the exhaust duct 11a of the venting system 7. Alternatively, the outlet duct 14 may form a unitary part of the exhaust duct 11a. The battery pack 6a and venting device 9a may be contained together in housing 19 that seals round the outlet duct 14.

The cross-sectional dimensions of the smooth internal surface 17 of the elastomeric fabric sleeve 16 are arranged to be the same as, or substantially similar to, those of the duct 14 abutting the sleeve. The planes of the internal surface 17 of the sleeve 16 are coplanar with the interior surface of the outlet duct 14. If the outlet duct 14 is cylindrical, the sleeve 16 is arranged to have a cylindrical interior surface, coaxial with the outlet duct. This means that fluid can flow across the flexible coupling 15 and smoothly into the outlet duct 14. If the outlet duct 14 is rectangular, the sleeve 16 is arranged to also be rectangular, having interior surfaces coplanar with the inner sides of the outlet duct 14 and substantially the same dimensions. The sleeve 16 and duct 14 form a substantially smooth and continuous fluid flow path.

When the burst disc 13 ruptures, any ensuing shock wave causes the sleeve 16 to inflate momentarily and hence absorb the shock. The sleeve 16 quickly returns to its normal dimensions, which correspond to the dimensions of the outlet duct 14. Thus, the resulting fluid flow is relatively smooth and low in turbulence throughout the rest of the venting system 7. This means that the ducts 11a to 11c, 12 of the venting system 7 can be made lighter in weight than was achievable hitherto.

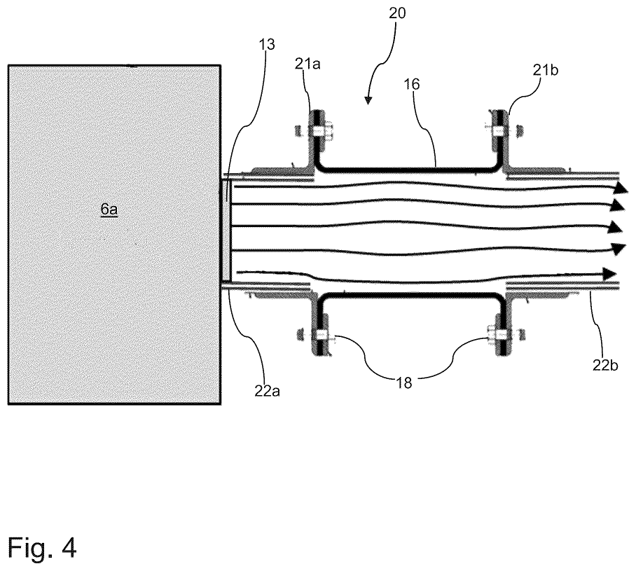

The smooth fluid low is indicated by the flow arrows in FIG. 4, which shows an alternative embodiment of the venting device. In this embodiment, the burst disc 13 is immediately downstream of a face of the housing of the battery pack 6a. The flexible coupling 20 comprises a fabric sleeve 16, as before, having a smooth internal surface 17. The end portions I 6a, 16b of the sleeve are connected to respective flanges 21a, 21b that surround the end portion of the sleeve. The flanges 21a, 21b are preferably formed of a metal, such as steel. The ends 16a, 16b of the elastomeric fabric sleeve are connected to the flanges by means of simple fasteners, such as nut and bolt fasteners 18. The provision of a simple fastening system facilitates assembly of the venting device, and also disassembly in case of replacement or repair of the flexible coupling 21 and/or the burst disc 13.

The outlet duct 22 has two portions: a first portion 22a is located between the burst disc 13 and the first flange 21a. The second portion 22b of the outlet duct is located downstream of the second flange 21b. The second duct portion 22b may be arranged to connect to one of the exhaust ducts 11a to 11c of the venting system 7 or may be formed as one piece with an exhaust duct. The internal surface 17 of the sleeve 16 is arranged to have substantially the same cross-sectional dimensions as both portions 22a, 22b of the outlet duct so that fluid may flow smoothly from one portion 22a of the outlet duct, across the flexible coupling 20, and into the other portion 22b of the outlet duct. The flanges 21a, 21b may be connected to the respective outlet duct portions 22a, 22b, by any known fixing method, such as by means of fasteners or by chemical bonding.

The fabric sleeve 16 is arranged to be coaxial with the outlet duct portions 22a, 22b. In the event of the burst disc 13 rupturing, the flexible sleeve 16 absorbs any shock wave emitted from the battery pack by momentarily expanding; the sleeve 16 then returns to its normal position, so that the flow of gases from the battery pack is undisturbed. Thus, the fluid flow entering the rest of the venting system 7 is relatively free of turbulence.

Variations may be made without departing from the scope of the invention. For example, the invention is applicable to other forms of vehicle other than an aircraft. Seals, such as O-rings, may be employed between components of the venting device of the present invention to prevent leakage of gases into the vehicle.

The elastomeric fabric sleeve 16 need not be formed from a fluoro-elastomer: silicon rubber, neoprene or other rubbers may be employed. The fabric may be coated with thermally insulating materials to further increase heat resistance. The fabric may be coated with chemically resistant materials. The elastomeric fabric sleeve 16 may be formed as a composite and/or may include reinforcing fibers, such as carbon fiber or glass fiber.

The internal shape of the elastomeric sleeve 16 may be circular, oval, square or rectangular, in dependence on the shape of the outlet duct 14; 22 and the ducts or pipes of the remainder of the venting system 7. The end portions 16a, 16b of the sleeve may be bonded onto, cured with, or over-molded on the flanges 14a, 21a, 21b and/or the battery pack wall instead of using fasteners 18. Alliteratively, a combination of joining methods may be employed to increase the security of the connection.

The burst disc 13 may take the form of a pressure relief valve or other safety valve. The burst disc may be circular, oval or a panel (i.e. rectangular} or have any other suitable geometry. The burst disc is preferably unidirectional but may be bi-directional. The burst disc may be single use, such that it needs to be replaced once activated, or multi-use. The burst disc may have a single bursting membrane or may have multiple membranes.

The venting device according to the invention is shown as being employed immediately adjacent or close to each battery pack of the electronic storage system. Such venting devices may be employed at other locations in the venting system—for example, close to the exit port near the skin of the aircraft. The venting devices 9a, 9b, 9c employed in a venting system may all be of the type shown in FIG. 3 or may all be of the type shown in FIG. 4. Alternatively, a combination of types of venting device may be utilized.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A venting device for an energy storage system comprising:
a fluid flow path including at least one outlet duct; a burst disc; and a flexible coupling downstream of the burst disc,
the flexible coupling comprising a sleeve of elastomeric material substantially coaxial with the outlet duct,
wherein a cross-sectional dimension of the flexible coupling and a cross-sectional dimension of the outlet duct are substantially the same.

2. The venting device as claimed in claim 1, wherein an interior surface of the sleeve is substantially smooth through the sleeve.

3. The venting device as claimed in claim 1, wherein the elastomeric material comprises a fluoro-elastomer.

4. The venting device as claimed in claim 1, wherein the outlet duct comprises a first portion between the burst disc and the flexible coupling; and a second portion downstream of the flexible coupling.

5. The venting device as claimed in claim 1, wherein the flexible coupling further comprises at least one flange arranged to support an end portion of the sleeve.

6. The venting device as claimed in claim 1, wherein the flexible coupling further comprises flanges arranged to support respective end portions of the sleeve.

7. The venting device as claimed in claim 5, wherein the sleeve is connected to the at least one flange by fasteners.

8. The venting device as claimed in claim 1, wherein the sleeve is circular in cross section.

9. The venting device as claimed in claim 1, wherein the sleeve is rectangular in cross section.

10. The venting device as claimed claim 1, wherein the energy storage system includes a housing with an outlet to the burst disc.

11. An energy storage system comprising:
a battery in a housing, and
the venting device as claimed claim 1.

12. An energy storage system comprising:
housings;
batteries each in a respective one of the housings, and
each of the housings includes the venting device as claimed in claim 1.

13. A vehicle comprising the energy storage system as claimed in claim 11.

14. The vehicle as claimed in claim 13, further comprising a venting system comprising at least one duct between the venting device and an exterior surface of the vehicle.

15. The vehicle as claimed in claim 13, wherein the vehicle is an aircraft.

16. An energy storage and vent assembly in an aircraft, the energy storage and vent comprising:
a battery;
a housing containing the battery;
a venting system configured to vent gas from the housing, wherein the venting system includes a burst disc and a flow path;
the burst disc is aligned within an opening the housing and adjacent the housing;
the flow path extends from the housing and in fluid communication with an exit port on an outer surface of the aircraft, wherein an inlet to the flow path is aligned with the burst disc;
the flow path including a first outlet duct and a flexible coupling attached to the first outlet,
wherein the first outlet duct has a first cross-sectional shape of a flow passage extending through the first outlet duct,
wherein the flexible coupling includes a deformable elastomeric sleeve having a third cross-sectional shape of a flow passage extending through the deformable elastomeric sleeve that is substantially the same as the first cross-sectional shape.

17. The energy storage and vent assembly of claim 16, wherein the flow path further includes a second outlet duct and the flexible coupling joins an outlet of the first outlet duct to an inlet of the second outlet duct, wherein the second outlet duct has a second cross-sectional shape of a flow passage extending through the second outlet duct, wherein the second cross-sectional shape is substantially the same as the first cross-sectional shape.

18. The energy storage and vent assembly of claim 16, wherein the first cross-sectional shape and the third cross-sectional shape each have substantially the same cross-sectional area.

19. The energy storage and vent assembly of claim 17, wherein the first outlet duct, the second outlet duct and the deformable elastomeric sleeve are aligned along a straight common axis.

20. The energy storage and vent assembly of claim 16, wherein a cross-sectional shape of the burst disc is substantially the same as the first cross-sectional shape.
